(19) United States
(12) Patent Application Publication
(10) Pub. No.: US 2019/0308503 A1
(43) Pub. Date: Oct. 10, 2019

(54) MOBILE DEVICE SYNCHRONIZATION WITH BLUETOOTH LOW ENERGY AND DATA COLLECTION

(71) Applicant: Driving Management Systems, Inc., San Francisco, CA (US)

(72) Inventor: Marwan Hannon, San Francisco, CA (US)

(21) Appl. No.: 16/448,048

(22) Filed: Jun. 21, 2019

Related U.S. Application Data
(62) Division of application No. 16/069,717, filed on Jul. 12, 2018.
(60) Provisional application No. 62/279,142, filed on Jan. 15, 2016.

(51) Int. Cl. B60K 35/00; H04W 76/14; H04W 4/00; H04W 4/80; H04W 76/10; H04W 4/40; H04W 4/48; B60W 40/09

(52) U.S. Cl. CPC B60K 35/00; H04W 76/14; H04W 4/00; H04W 4/80; H04W 4/90; H04W 4/40; H04W 4/48; B60W 40/09; H04W 76/10

(57) ABSTRACT

A method for operating a mobile device includes activating a driving management system that is configured to communicate via Bluetooth Low Energy (BLE), establishing a communication channel between the driving management system and a mobile device, transmitting information associated with the mobile device to the driving management system, and synchronizing operation of the mobile device with the driving management system. A method for communicating information by a driving management system includes determining that a location of a mobile device corresponds to a location of a driver of a vehicle, and disabling data entry to a navigation system by the mobile device. A method for collecting data may include activating a driving management system, receiving driving habit information, determining a location of a mobile device wherein the location is within a predetermined detection zone, receiving identification information from the mobile device, associating the identification information with the driving habit information.

### PRIORITY

This application is a U.S. National Stage Entry under 35 U.S.C. § 371 of International Application No. PCT/US2017/013398, entitled MOBILE DEVICE SYNCHRONIZATION WITH BLUETOOTH LOW ENERGY AND DATA COLLECTION, filed Jan. 13, 2017, which claims the benefit under 35 U.S.C. § 119(e) of U.S. Provisional Application Ser. No. 62/279,142, entitled MOBILE DEVICE SYNCHRONIZATION WITH BLUETOOTH LOW ENERGY AND DATA COLLECTION, filed Jan. 15, 2016, the contents of both of which are incorporated herein by reference in their entirety and for all purposes.

### BACKGROUND

It has been found that approximately 40-50% of service calls to auto dealerships are from drivers who have trouble synchronizing (syncing) their mobile devices with the hands-free system of a vehicle. Further, in many cases, when a vehicle is travelling, the navigation screen of the vehicle is disabled to prevent a driver from entering location information while the vehicle is moving. Disabling the navigation screen in this manner may reduce the probability of a potential accident. Unfortunately, the navigation screen is also disabled for the passenger sitting next to the driver because the navigation system in the vehicle cannot distinguish between the driver and the passenger. Additionally, insurance companies may choose to collect information on the driving habits of those they insure. However, current technology can only report on how a vehicle is driven and does not distinguish the driving habits of different drivers of the same vehicle. Given these limitations in the present technology, it may be useful to devise features in both the vehicle system and the mobile device to allow the vehicle system to synchronize with a mobile device of a non-driver while restricting such synchronization with a mobile device of a driver. In this manner, the vehicle system may differentiate the activities of a driver from a non-driver and respond accordingly.

### SUMMARY

Systems and methods are disclosed for using a Bluetooth Low Energy (BLE) system in a mobile device to automatically sync with a hands-free system and/or a navigation system of a vehicle. Systems and methods are disclosed for communicating information to a vehicle navigation system from a mobile device upon determining that a location of a mobile device within the interior of a vehicle does not correspond to a driver. Systems and methods are disclosed for collecting information regarding identification of a driver of a vehicle based on the location of a mobile device within an automobile and regarding the driving habits of the driver for insurance applications.

In one non-limiting aspect, a mobile device application utilizes BLE technology. Mobile devices may have BLE devices, such as circuits, chips, ICs, etc., built into them. In one non-limiting aspect, a mobile device may synchronize with a hands-free system of a vehicle based on communication between the BLE devices in a driving management system. The driving management system may be located in the vehicle. The BLE devices may be located in the mobile device. In one non-limiting aspect, the Bluetooth system in the mobile device may be synchronized with the hands-free system of the vehicle. Such an action could be accomplished through a mobile device application on the mobile device according to an automated process. The mobile device application and synchronization process may work on wearable devices as well and allow for synchronization between the mobile device and a wearable device. A hands-free system may, for example, enable a hands-free operation which, in one non-limiting example may include an operation that does not require the use of a user's hands. One non-limiting example of a hands-free operation may include a user generating a verbal command to initiate an operation, such as establishing a communication channel between the hands-free system and a mobile device of the user.

In one non-limiting aspect, a mobile device application may be a location based system that can differentiate between a mobile device of a driver and a mobile device of a passenger. Using BLE, a mobile device application may allow the passenger to access a navigation system or other functions of the vehicle that may be disabled for the driver. Operably, the mobile device application and the driving management system can distinguish between a driver's mobile device and a passenger mobile device. The passenger may be able to access the navigation system or other function through a mobile device application on their mobile device. According to some non-limiting aspects, access may be made directly to a headset unit of the mobile device of the passenger or may be made through a map application on the mobile device. The driver may still be prevented from performing such function(s) since the mobile device of the driver remains disabled.

In one non-limiting aspect, a mobile device application can collect data associated with the driver, such as, for example, data related to the driving habits of a driver. As a non-limiting example, the driver may be identified based on a location of the driver's mobile device. Current technology can only report on how the vehicle is driven. If multiple drivers share the use of the same car, there is no way for the vehicle to determine who is driving safely or recklessly. Through the mobile device application, information associated with a specific driver, such as driving habits of one driver of the multiple drivers sharing the same car, may be collected and reported. In some non-limiting examples, the data related to the driving habits may be reported to an individual, group of individuals, or an organization, such as law enforcement officials or the insurance carrier of a driver. Some non-limiting examples of driving habits may include the speeds that a driver typically drives, the frequency and length that the driver depresses a brake pedal, and the manner in which the driver uses a steering wheel.

Bluetooth Low Energy (BLE) is a wireless personal area network technology designed and marketed by the Bluetooth Special Interest Group which is directed to applications in healthcare, fitness, beacons, security, and home entertainment. Compared to Classic Bluetooth, BLE is intended to provide considerably reduced power consumption and cost while maintaining a similar communication range.

### FIGURES

FIG. 1 illustrates a vehicle that includes a cabin for accommodating an individual in a driver seat;

FIG. 2 illustrates one non-limiting aspect of a mobile device detection and control system;

FIG. 3 illustrates an interior portion of the vehicle comprising one non-limiting aspect of the mobile device detection and control system located within the dashboard of the vehicle;

FIG. 4 illustrates one non-limiting aspect of a flow chart for determining the presence of a mobile device located in a predetermined detection zone within a vehicle;

FIG. 5 shows a schematic view of an illustrative electronic device;

FIG. 6 shows one non-limiting aspect of an input/output subsystem for an electronic device;

FIG. 7 shows one non-limiting aspect of a communications interface for an electronic device;

FIG. 8 shows one non-limiting aspect of a memory subsystem for an electronic device;

FIG. 9 illustrates one non-limiting aspect of a flow chart for using BLE technology in a mobile device to automatically synchronize with a system of a vehicle;

FIG. 10 illustrates one non-limiting aspect of a flow chart for communicating information to a vehicle navigation system from a mobile device upon determining that a location of the mobile device within the interior of a vehicle does not correspond to a driver; and

FIG. 11 illustrates one non-limiting aspect of a flow chart for collecting information regarding identification of a driver of a vehicle based on location of a mobile device within an automobile along with identification of driving habits associated with the vehicle.

FIG. 12 shows a diagram of a route from which information may be collected by a driving management system according to non-limiting aspects of the present disclosure.

### DESCRIPTION

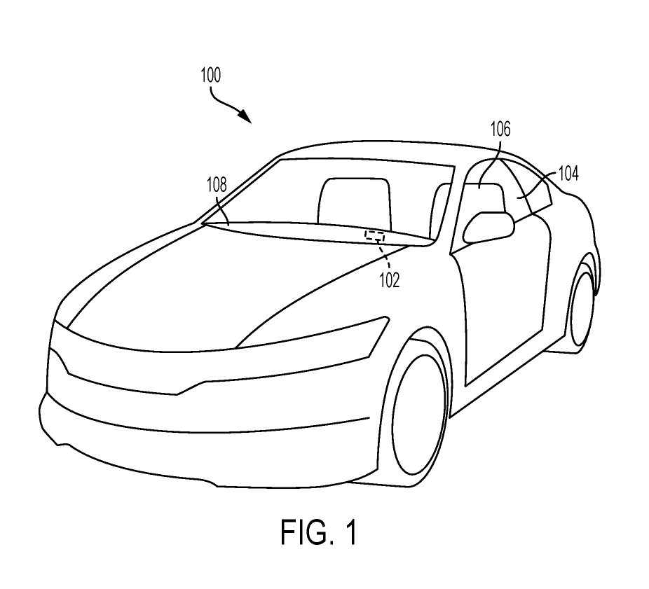

FIG. 1 illustrates a vehicle 100 that includes a cabin 104 for accommodating an individual in a driver seat 106. It will be appreciated in accordance with the present disclosure that the term vehicle is used broadly and is meant to include any kind of transportation vehicle. For example, the vehicle 100 may be any type of automobile, truck, sport utility vehicle, aircraft, watercraft, spacecraft, or any other means of transportation, or combinations thereof, where communications by the driver using a mobile device is to be detected and controlled.

Disposed on or within the dashboard 108 of the vehicle 100 is a mobile device detection and control system 102. In one non-limiting aspect, the mobile device detection and control system 102 is configured to detect the presence of a mobile device located in the driver seat 106 side of the vehicle 100 and control the operation of the mobile device. In one non-limiting aspect, controlling the operation of the mobile device may comprise redirecting the operation of the mobile device to a hands-free alternate system. A hands-free system may, for example, enable a hands-free operation, which in one non-limiting example may include an operation that does not require the use of a user's hands, such as the user generating a verbal command to initiate an operation comprising establishing a communication channel between the hands-free system and a mobile device of the user. In other non-limiting aspects, at least one element or component of the mobile device detection and control system 102 may be located in another area of the vehicle 100.

It may be desirable to place detection elements of the mobile device detection and control system 102 as close to the driver as possible. For example, sensors and directional antennas of the mobile device detection and control system 102 may be located in proximity to the driver seat 106. Such a configuration may provide for more precise detection of the presence of the mobile device in the driver seat 106 side of the vehicle 100 and prevent control of mobile devices belonging to other persons located within the vehicle 100 thereby allowing, for example, persons in the passenger seats to use their mobile devices while the driver is unable to do so. Other elements or components such as control logic may be located in other locations of the vehicle 100 away from the driver seat 106.

In one non-limiting aspect, the mobile device detection and control system 102 is configured to detect signal transmissions from mobile devices located in or in proximity to a detection zone. In accordance with the described non-limiting aspects, the detection zone may be defined as a zone substantially in or in proximity to the driver seat 106 side of the vehicle 100. In other non-limiting aspects, however, the detection zone may be any predefined zone within the vehicle 100, without limitation. In one aspect, the detection portion of the mobile device detection and control system 102 may be tuned to detect signal transmissions in frequency bands used by conventional mobile telephones operating in common cellular channels. Such cellular channels may include, for example, voice channels, data channels, or other communication channels. Once the signals are detected, the mobile device detection and control system 102 may wirelessly control the operation of the mobile device in one or more ways.

For example, in one non-limiting aspect, the mobile device detection and control system 102 may transmit a control signal to disable one or more operations of a mobile device, such as, for example, a mobile device in possession of the driver. Such operations may include, without limitation, texting, originating a phone call, receiving internet data, taking a photograph, or other operations commonly associated with mobile devices. When the control signal is transmitted by the mobile device detection and control system 102 and received by the mobile device, the mobile device or other communication device within the detection zone may be rendered fully inoperable, partially inoperable, or operable only in a state of limited capacity. The control signal may control at least one function of the mobile device such that the mobile device is disabled or limited in the performance of at least one communication function of the mobile device. In one non-limiting aspect, the control signal may be communicated to the mobile device through a secondary channel, such as a Bluetooth wireless connection or any other connection that is secondary to the primary cellular communication channel. In some non-limiting aspects, the control module may communicate on the primary communication channel of the mobile device only or in addition to one or more secondary channels.

Accordingly, the mobile device detection and control system 102 can either completely block the ability to receive or send a call on a mobile device, or sufficiently limit the mobile device signal so as to make the mobile device usage undesirable. For example, if the control signal interrupts a sufficient portion of a telephone conversation on a mobile device, the user of the mobile device may either postpone the conversation or remove the vehicle from a driving state so the conversation can continue uninterrupted. In another non-limiting aspect, the mobile device detection and control system 102 may disable the operation of certain components or functions of the mobile device. For example, the keyboard portion of the mobile device may be rendered inoperative to prevent the user from using the text messaging function of the mobile device. In another non-limiting aspect, the mobile device detection and control system 102 may direct the operation of the mobile device to a hands-free operation. These and other non-limiting aspects are discussed in more detail hereinbelow.

In one non-limiting aspect, the mobile device detection and control system 102 may initiate a detection process by transmitting probing signals to detect the presence of a mobile device within a detection zone. Such probing signals may be, for example, electromagnetic or audio signals. Once the probing signals are transmitted, the detection and control system 102 may wait for an echo signal reflected by the mobile device or a response signal transmitted by the mobile device. If the detection and control system 102 detects the echo signal or a transmission by the mobile device, the detection and control system 102 transmits a control signal to control the operation of the mobile device. For example, in one non-limiting aspect, the detection and control system 102 may transmit a control signal to disable the operation of the mobile device in a manner that prevents at least one communication mechanism of the mobile device. A communication mechanism may be for example, a mechanism such as a mechanism to send or receive a call, a mechanism for the mobile device to connect to a communication network, or a mechanism to send or receive a text message. In another non-limiting aspect, the detection and control system 102 may reroute communications from the mobile device to a hands-free system in the vehicle, such as a Bluetooth communication system. In one non-limiting example, a mobile device located outside of the detection zone may not receive the probing signal and may therefore not respond to the mobile detection and control system 102. As a result, a mobile device outside of the detection zone may not receive a control signal capable of altering the functions or operations of the mobile device.

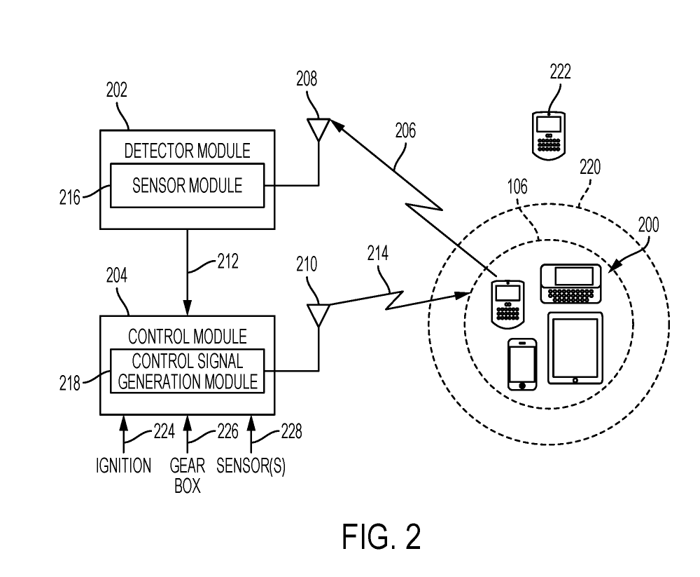

FIG. 2 illustrates one non-limiting aspect of a mobile device detection and control system 102. In one non-limiting aspect, the mobile device detection and control system 102 is configured to detect the presence of a mobile device 200 located in or in proximity to the driver seat 106 area of the vehicle 100. Once the mobile device 200 is detected, the mobile device detection and control system 102 may be configured to control the operation of the mobile device 200. In one non-limiting aspect, the mobile device detection and control system 102 comprises a detector module 202 and a control module 204 coupled to the detector module 202. In one non-limiting example, the detector module 202 may comprise a multi-band antenna 208 configured to receive electromagnetic signals 206 transmissions from the mobile device 200 and the control module 204 may comprise an antenna 210 to transmit a control signal 214 to the mobile device 200. In various non-limiting aspects, the detector module 202 and the control module 204 may share an antenna when these components are located in proximity to each other.

In various non-limiting aspects, the mobile device 200 may be implemented as a handheld portable device, computer, mobile telephone, sometimes referred to as a smartphone, tablet personal computer (PC), laptop computer, or any combination thereof. Examples of smartphones include, for example, Palm® products such as Palm® Treo® smartphones (now Hewlett Packard or HP), Blackberry® smart phones, Apple® iPhone®, Motorola Droid®, and the like. Tablet devices include the iPad® tablet computer by Apple® and more generally a class of lightweight portable computers known as Netbooks. In some non-limiting aspects, the mobile device 200 may comprise, or be implemented as, any type of wireless device, mobile station, or portable computing device with a self-contained power source (e.g., battery) such as a laptop computer, ultra-laptop computer, personal digital assistant (PDA) with communications capabilities, cellular telephone, combination cellular telephone/PDA, mobile unit, subscriber station, user terminal, portable computer, handheld computer, palmtop computer, wearable computer, media player, pager, messaging device, data communication device, and so forth.

In one non-limiting aspect, the detector module 202 is configured to detect presence of the mobile device 200 located within a detection zone 220 defined as a three-dimensional zone within or in proximity to the driver seat 106. Methods of detecting the presence of the mobile device 200 may vary based on the wireless technology communication standards used by the mobile device 200. Examples of wireless technology communication standards that may be used in the United States, for example, may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), 4G systems, CDMA-2000, Universal Mobile Telephone System (UMTS) systems, Integrated Digital Enhanced Network (iDEN) (a TDMA/GSM variant) and so forth. The frequency and signal strength of the radio frequency (RF) signals transmitted by the mobile device 200 depend on the network type and communication standard. The detector module 202 detects the RF signal, or more generally, the electromagnetic signal 206, transmitted by the mobile device 200. Accordingly, in one non-limiting aspect, the detector module 202 may be configured to lock onto specific cellular frequencies or cellular frequency bands or may be configured to scan all the available cellular frequencies or cellular frequency bands and lock onto the RF signal emitted by the mobile device 200.

In one non-limiting aspect, the detector module 202 may comprise a sensor module 216 coupled to the multi-band antenna 208. The sensor module 216 may be tuned to detect an electromagnetic signal 206, e.g., RF signal, emitted at a predetermined signal strength by the mobile device 200 and received by the antenna 208. It will be appreciated that the signal strength or power of the electromagnetic signal 206 emitted by the mobile device 200 will be greatest when the mobile device 200 is making an outbound call or otherwise communicating with a cellular base station (e.g., searching for base station signals or in contact with a base station or cell). Very little electromagnetic energy is radiated when the mobile device 200 is turned off or is not communicating with the cellular base station. In the latter case, when the mobile device 200 is turned on but is not communicating with the cellular base station, the mobile device 200 possibly may be detected only if the detector module 202 comprises extremely sensitive components. Most conventional mobile devices 200 radiate energy at a power level ranging from about 0.5 milliwatts (mW) to about several hundred mW. A detector module 202 of suitable sensitivity can be configured to detect electromagnetic signals 206 in this range of power level. Many radio electronic equipment are capable of detecting a low-level power electromagnetic signal 206. This capability is one reason why airlines are very sensitive about electronic equipment that operates at key points of the flight, why some electronic equipment should be turned off near blast sites, and why cellular phones should be turned off around some types of hospital equipment.

In one non-limiting aspect, the sensor module 216 is configured to exploit the electromagnetic signal 206 generated by the mobile device 200 when it is communicating with the cellular base station. When the sensor module 216 of the detector module 202 detects the electromagnetic signal 206, the detector module 202 determines the presence of a mobile device 200 located within the detection zone 220, i.e., in or in proximity to the driver seat 106, and communicates a signal 212 to the control module 204. In one non-limiting aspect, when the control module 204 receives the signal 212 from the detector module 202, the control module 204 may transmit a control signal 214 via the antenna 210 that is detectable only by a mobile device 200 that is located in the detection zone 220. In various non-limiting aspects, the electromagnetic control signal 214 may be a signal that disables at least one operation of the mobile device 200, may disable certain functionality of the mobile device 200, or may redirect the operation of the mobile device 200 to a hands-free operation. The control module 204 may be disposed in communication with a system of the vehicle 100, such as the ignition system 224, a transmission system 226, or a variety of sensors 228. The control module 204 logic may also monitor a function of a system of the vehicle 100 in addition to the detection of the presence of the mobile device 200. According to one non-limiting aspect, the control module 204 may be activated only when a monitored function of the vehicle 100 is activated. For example, when the sensor module 216 detects the presence of a mobile device 200 in the detection zone 220, the control module 204 may be activated only when the vehicle 100 is turned on, when the vehicle 100 is moved out of park or otherwise put in gear, or when one or more sensors detect that the vehicle 100 is in an operating state.

In one non-limiting aspect, the sensor module 216 may comprise an energy harvester to harvest the energy of the electromagnetic signal 206 transmitted by the mobile device 200. The energy harvester may receive the radiated energy at the antenna 208 and convert the energy into a voltage potential to energize the detector module 202 and communicate the signal 212 to the control module 204. In other non-limiting aspects, the energy harvester may be separate from the sensor module 216 and the voltage potential produced by the energy harvester may be used to energize the sensor module 216. In non-limiting aspects, the voltage potential produced by the energy harvester may be employed to determine the presence of a mobile device 200 in the detection zone 220. Accordingly, the sensitivity of the sensor module 216 may be adjusted such that the energy harvester is sensitive only to the radiated energy levels corresponding to the mobile device 200 located within the detection zone 220 and not sensitive to the radiated energy levels corresponding to mobile devices 222 located outside the detection zone 220. In this manner, passengers may use their mobile devices 222 outside the detection zone 220 without triggering the detector module 202.

In other non-limiting aspects, the detector module 202 may be coupled to the electrical system of the vehicle 100 and powered by the vehicle battery, or may be powered by a separate battery. In such non-limiting aspects, the detector module 202 may comprise a frequency scanning and power level measurement module that is configured to measure the power of the electromagnetic signal 206 transmitted by the mobile device 200. Accordingly, the sensitivity of the detector module 202 can be tuned to trigger the detector module 202 to transmit the detection signal 212 to the control module 204 when the detector module 202 detects transmitted power that corresponds to the mobile device 200 being located in the detection zone 220. Similarly, the sensitivity of the detector module 202 can be tuned so that transmitted power radiated by the mobile devices 222 located outside the detection zone 220 do not trigger the detector module 202. In one non-limiting example, this may be accomplished by locating a directional multi-band antenna 208 such that it is maximally sensitive to the transmitted power radiated by the mobile device 200 located in the detection zone 220 and minimally sensitive to transmitted power radiated by the mobile devices 222 located outside the detection zone 220.

In one non-limiting aspect, the control module 204 may comprise a control signal generation module 218 coupled to the antenna 210. The control signal generation module 218 may be in communication with the antenna 210. The antenna 210 may emit a control signal 214 to thereby prevent or otherwise limit the ability of the mobile device 200 to make or receive calls. The control signal generation module 218 and the antenna 210 may be powered by the electrical system of the vehicle 100, or may be powered by a separate battery. The control signal generation module 218 may be a device that transmits a control signal 214 that limits the operation of the mobile device 200.

In accordance with one aspect, the control signal generation module 218 may be mounted in the vehicle 100. In one non-limiting example, when activated, the control signal generation module 218 may inhibit the ability to send or receive a mobile telephone call or text message of a mobile device 200 located in the detection zone 220. The extent of the zone in which the mobile device 200 is located may be controlled based on the operating power of a control signal 214 emitted by the antenna 210 in communication with the control signal generation module 218. Alternatively, the extent of the zone may be determined based on the geometric transmission properties of a directional antenna. Thus, for example, the control signal generation module 218 may control telephone calls or text messages to or from the mobile device 200 located within a predetermined distance, such as, for example, 1-3 feet from the location of the control signal generation module 218 based on the operating power of the emitted control signal 214. Additionally or alternatively, the control signal generation module 218 may control such telephone calls or text messages based on a location of the mobile device 200 with respect to the transmission geometry of a directional antenna. However, a mobile device 222 outside of the detection zone 220 (for example, a passenger's device) may not be limited to receive or initiate mobile telephone calls or send text messages.

In one non-limiting aspect, the antenna 210 may be positioned under the dashboard of the vehicle 100 or up on the driver side windshield. Alternatively, a directional antenna could be placed in the driver's seat to limit the ability of the driver to make calls or send text messages.

In one non-limiting aspect, the control module 204 may be used to prevent communications by the operator of the vehicle 100 when the mobile device 200 is detected in the detection zone 220 in combination with a state of a vehicle component such as, for example, an ignition switch, transmission switch, or other vehicular sensor mechanism. In one non-limiting aspect, an ignition switch may be monitored to cause the control signal generation module 218 to broadcast the control signal 214 only when a mobile device 200 is detected in the driver seat 106 side of the vehicle 100 and the ignition switch is turned on. However, the operator of the vehicle 100 could turn off the ignition switch or transition the vehicle 100 to an off state in order to establish outside communications. The control signal generation module 218 could thus prevent any further communications until the vehicle 100 was transitioned to an off state. In another non-limiting aspect, the control signal generation module 218 may be activated only when a mobile device 200 is detected in the detection zone 220 and an automatic transmission in the vehicle 100 is transitioned from a “park” state to an operational state wherein the vehicle 100 may move. When the control signal generation module 218 is activated, the operator of the vehicle 100 must stop any motion of the vehicle 100 and either transition the transmission to the “park” state or transition the vehicle 100 to an off state, such as by turning off the engine, to operate the mobile device 200.

In one non-limiting aspect, the control module 204 and/or control signal generation module 218 may be configured to operate within the confines of the vehicle 100. In some cases, the antenna 210 coupled to the control signal generation module 218 of the control module 204 may be configured with a predetermined power level and directional attributes to direct the control signal 214 solely to the detection zone 220 so that non-driving occupants of the vehicle 100 can continue to operate other mobile devices 222. In such cases, the control signal 214 may be generally confined within the detection zone 220 of the vehicle 100. In some non-limiting aspects, the control signal 214 may be localized to other areas within the vehicle 100 so that operation of a mobile device in those areas, such as an area in proximity to the driver seat 106, may be disabled while mobile devices located outside of those areas are operational.

In various non-limiting aspects, the antenna 210 and power level of the control signal 214 may be configured so that the control signal 214 is delivered precisely to the detection zone 220. In one non-limiting aspect, the delivery may be implemented with a directional antenna located within the vehicle 100 where maximum control is delivered to the detection zone 220, while minimal power is delivered outside the detection zone 220. In such non-limiting aspects, the detector module 202 may be configured to indiscriminately detect any transmissions from any mobile devices 200, 222 within the vehicle 100. The control module and/or control signal generation module 218 may be configured only to transmit control signals to the detection zone 220 to control the mobile device 200 within the detection zone 220 without affecting the mobile device 222 outside the detection zone 220. Therefore, the design of the detector module 202 may be simplified because the detector module 202 may detect transmission from a mobile device without regard to whether the mobile device is located within or outside of the detection zone 220.

In one non-limiting aspect, the control module 204 may permit incoming calls to the mobile device 200 but prohibit outgoing calls to the mobile device 200. When the detector module 202 detects the electromagnetic signal 206 from an attempted outgoing call by the mobile device 200, the detection signal 212 activates the control module 204 to transmit the control signal 214. In such a non-limiting aspect, the detector module 202 may comprise additional modules to discern the identity of the mobile device 200 and enable the control module 204 to transmit the control signal 214 after the identity of the mobile device 200 is confirmed.

In other non-limiting aspects, the sensor module 216 may be used to detect and permit or deny any type of operation of the mobile device 200. For example, calls may be received by the mobile device 200 or alternatively, such calls may be prevented or limited. In another example, some calls, such as emergency calls, may be permitted to be placed. Any other function of the mobile device 200 that may be detected may be selectively permitted or disabled by the control signal generation module 218.

In one non-limiting aspect, the mobile device 200 may receive the control signal 214 and operate in a reduced function mode. For example, the mobile device 200 may be prohibited from initiating a phone call except for predefined exceptions, such as 9-1-1 emergency calls. In another example, the mobile device 200 may be permitted to receive all calls or calls from a predefined list of callers while being prohibited from placing calls. Various reduced function modes may be used and in some non-limiting aspects, a setting may define the precise operations allowed.

In one non-limiting aspect, control module 204 initiates the detection process by transmitting probing signals to detect the presence of a mobile device 200 within a detection zone 220. Once the probing signals are transmitted, the detector module 202 waits for an echo signal reflected by the mobile device 200 or a response signal transmitted by the mobile device 200. If the detector module 202 detects the echo signal or a transmission by the mobile device 200, the control module 204 transmits a control signal 214 to control the operation of the mobile device 200. For example, in one non-limiting aspect, control signal generation module 218 may cause the control module 204 to transmit a control signal 214 to disable the operation of the mobile device 200. In another non-limiting aspect, the control module 204 may reroute communications to a hands-free system, such as a Bluetooth communication system.

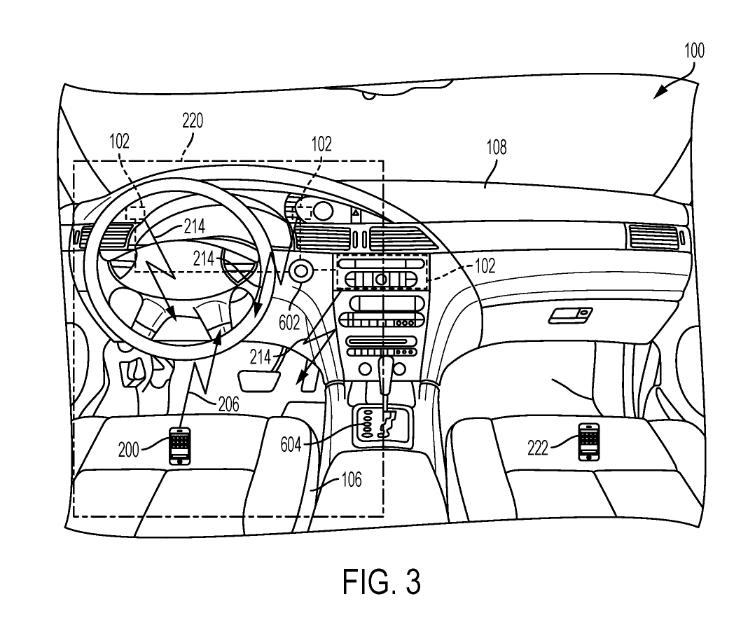

FIG. 3 illustrates an interior portion of the vehicle 100 comprising one non-limiting aspect of the mobile device detection and control system 102 located within the dashboard 108 of the vehicle 100. FIG. 3 illustrates as phantom three potential locations within the dashboard 108 where the mobile device detection and control system 102 can be located. It will be appreciated that the detection and control system 102 may be located in one or more of these locations on or within the dashboard 108. It may be preferable that the detection and control system 102 be located within the dashboard 108 to prevent user tampering. Accordingly, the detection and control system 102 is shown as a phantom to indicate that the detection and control system 102 is located within the dashboard 108. In another non-limiting aspect, the control module 204 may be configured with a data collection process to record situations, such as when the detection and control system 102 was deactivated by an owner of the vehicle 100 with or without the help of a car mechanic. Such a tamper recording and detection feature may be helpful in post accident investigations to determine if the detection and control system 102 was disabled. For example, a determination that the detection and control system 102 was disabled may result in the voiding of insurance coverage.

With reference now to FIGS. 1-3, the mobile device detection and control system 102 comprises a detector module 202 and a control module 204 coupled to the detector module 202. The detector module 202 detects the presence of a mobile device 200 within the detection zone 220. When the detector module 202 detects the presence of a mobile device 200 within the detection zone 220, the control module 204 activates the control signal generation module 218, which generates the control signal 214 for transmission by the control module 204. The control signal 214 may limit or disable the operation of the mobile device 200 when it is located within the detection zone 220 without limiting or disabling the mobile device 222 located outside the detection zone 220.

In one non-limiting aspect, the mobile device detection and control system 102 may be triggered when the driver enters the vehicle 100. Upon being triggered, the mobile device detection and control system 102 may be initialized and goes into a detection mode. The detection mode is a process wherein the mobile device detection and control system 102, through one or more sensor(s) and logic detects the presence of all electromagnetic signals 206 such as RF, Wi-Fi, Cellular, and Satellite communications signals from the mobile device 200. In one non-limiting aspect, the detection process is initiated by the mobile device detection and control system 102. Therefore, the detection process is not dependent upon a driver's interaction to initiate the detection process. Decoupling the process from the driver is advantageous because it avoids reliance on self policing, which currently has failed to work even with laws presently enacted. Thus, the triggering condition may be the activation of a switch such as an ignition switch 602 of the vehicle 100 or deactivation of a “park” sensor 604 of an automatic transmission of the vehicle 100, among other sensors.

Accordingly, upon ignition of the vehicle 100, the mobile device detection and control system 102 would initiate the detection process to control the operation of the detection module 202 and the control module 204. In accordance with the detection process, sensor module 216 may initiate sensing or scanning for any type of communication signals 206 emitted by a mobile device 200 in the detection zone 220, which may be defined as being within the driver side 106 area of the vehicle 100. In one non-limiting aspect, the sensor module 216 may be located within the dashboard 108 console and/or within a microphone of a hands-free set. This configuration would hide the sensor module 216 and prevent drivers from tampering with the mobile device detection and control system 102 by blocking the sensor module 216 or preventing activation of the detection process. In one non-limiting aspect, the sensor module 216 may be coupled to the ignition switch 602 to render the vehicle 100 inoperable if the sensor module 216 is blocked.

Thus, the detection process comprises detecting communication signals 206 emitted by the mobile device 200 located within the detection zone 220 to prevent the driver from adequately using the mobile device 200. The detection process may further comprise controlling a mobile device 200 in the detection zone 220. However, the detection process may avoid controlling a mobile device 222 outside the detection zone 220. Once the detection process is initiated, if the mobile device 200 is a smart phone and is detected within the detection zone 220, in one non-limiting aspect, the mobile device detection and control system 102 can automatically connect to the vehicle 100 hands-free communication system. If no hands-free communication system is available, the mobile device 200 would be disabled by the control signal 214 transmitted by the control module 204. However, the mobile device detection and control system 102 may allow emergency calls, such as 911 calls.

Additionally, once the detection process is initiated, if the mobile device 200 is a smart phone and is detected within the detection zone 220, in one non-limiting aspect, the mobile device detection and control system 102 is configured to disable text messaging features of the mobile device 200 such as inbound text messages, outbound text messages, or both inbound text messages and outbound text messages. In one non-limiting aspect, all inbound text messages or all outbound text messages may be saved. In one non-limiting aspect, the mobile device detection and control system 102 is configured to read a text message via the hands-free communication system, such as a Bluetooth system, as well as to reply via voice activated text message through the hands-free communication system. Reading the voice activated text message may comprise, for example, verbalizing the content of the text message by the mobile device detection and control system 102 such that a user of the mobile device may hear the text message from a speaker within the vehicle. The text message may be an inbound text message. The verbalizing of the inbound text message content may be achieved via, for example, any suitable text to speech (TTS) software. Suitable TTS software may include, for example, software such as IVONA TTS Software, available from IVONA Software Sp. z o.o., Gdansk, Poland and Natural Reader, available from NaturalSoft Ltd., Vancouver, BC, Canada.

Replying via voice activated text message may comprise, for example, the user of the mobile device verbalizing the content of a text message that a user desires to send to another individual or group of individuals. A microphone within the vehicle may receive the user's verbalization. In one non-limiting example, the user may verbalize the text message content with the voice of the user. The text message may be an outbound text message. The text message the user desires to send may comprise information indicating the identity of the user that desires to send the text message. The mobile device detection and control system 102 may convert the verbalized text message via, for example, any suitable voice recognition software. Suitable voice recognition software may include, for example, software such as Dragon Professional Individual, available from Nuance Communications, Inc., Burlington, Mass., and Five9 IVR System, available from Five9, Inc. San Ramon, Calif. In a non-limiting aspect, the control signal generation module 218 may communicate with the mobile device 200 through a secondary channel, such as a Bluetooth wireless connection or any other connection that is secondary to the primary cellular communication channel. In some non-limiting aspects, the control signal generation module 218 may communicate only on the primary communication channel of the mobile device 200 or additionally, may communicate on one or more secondary cellular communication channels.

Moreover, once the detection process is initiated, if the mobile device 200 is a smart phone and is detected within the detection zone 220, in one non-limiting aspect, the mobile device detection and control system 102 may be configured to disable emailing features, such as inbound email messages, outbound email messages, or both inbound email messages and outbound email messages. In one non-limiting aspect, all inbound emails or all outbound emails may be saved. The mobile device detection and control system 102 may be configured through a logic module to read back the email via the hands-free system as well as reply via voice activated email through the Bluetooth/hands-free communication system.

Furthermore, once the detection process is initiated, if the mobile device 200 is an iPad® or a Netbook® device and is detected within the detection zone 220, in one non-limiting aspect, the mobile device detection and control system 102 may be configured to disable text messaging features, emailing features, or both text messaging features and emailing features. All inbound emails may be saved. The mobile device detection and control system 102 may be configured through the logic module to read back the email or text via the hands-free communication system as well as reply via voice activated email or text through the hands-free communication system. In some non-limiting examples, a driving management system may comprise the mobile device detection and control system 102 disclosed above and depicted in FIGS. 1-3, including the hardware components and their functions of the mobile device detection and control system 102. The driving management system may comprise any combination or subcombination of the hardware components of the mobile device detection and control system 102. Furthermore, the driving management system may include additional hardware components relative to any combination or subcombination of the hardware components of the mobile device detection and control system 102. In one non-limiting example, the driving management system may comprise a configuration of hardware components that does not include any of the hardware components of the mobile device detection and control system 102.

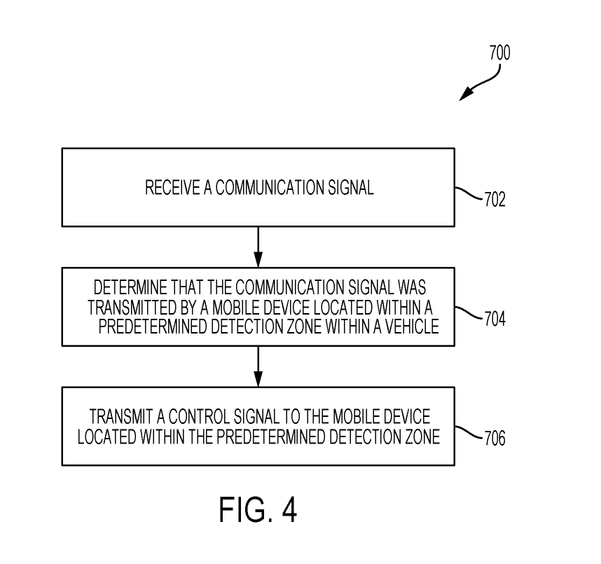

FIG. 4 illustrates one non-limiting aspect of a flow chart 700 for determining the presence of a mobile device located in a predetermined detection zone within a vehicle. With reference now to FIGS. 1-4, in one non-limiting aspect, the detection module 202 receives 702 a communication signal 206. The detection module 202 determines 704 that the communication signal 206 was transmitted by a mobile device 200 located within a predetermined detection zone 220 within a vehicle 100. The control module 204 transmits 706 a control signal 214 to the mobile device 200 located within the predetermined detection zone 220.

In one non-limiting aspect, the detection module 202 transmits a detection signal 212 to the control module 204 when a voltage potential V_{d} corresponding to the location of a mobile device 200 substantially equals or is greater than a predetermined threshold value Vₜ, wherein the voltage potential of the predetermined threshold value Vₜ indicates the presence of the mobile device 200 within the predetermined detection zone 220.

In one non-limiting aspect, the detection module 202 scans for a plurality of frequency bands associated with the mobile device 200. A radiated power level of the communication signal 206 that may be found in any of the plurality of frequency bands received by the detection module 202 is monitored by the detection module 202. The detection module 202 transmits a detection signal 212 to the control module 204 when a voltage level corresponding to the measured radiated power level substantially equals or is greater than at least predetermined value Vₜ. The detection module 202 may harvest the energy of the received communication signal 206 and generate a voltage potential corresponding to the location of the mobile device 200 within the detection zone 220.

In one non-limiting aspect, the control module 204 monitors a functional system of the vehicle 100. The transmission of the control signal 214 is activated when the monitored functional system is activated and the detection module 202 determines that the communication signal was transmitted by the mobile device 200 located within the predetermined detection zone 220. In one non-limiting aspect, the functional system of the vehicle 100 is an ignition system 224, the transmission system 226, a sensor 228, or any combination or subcombination thereof. In one non-limiting aspect, when the control module 204 receives the detection signal 212, the control module 204 may fully disable the mobile device 200, disable at least one function of the mobile device 200, or redirect the operation of the mobile device 200 to a hands-free alternate system.

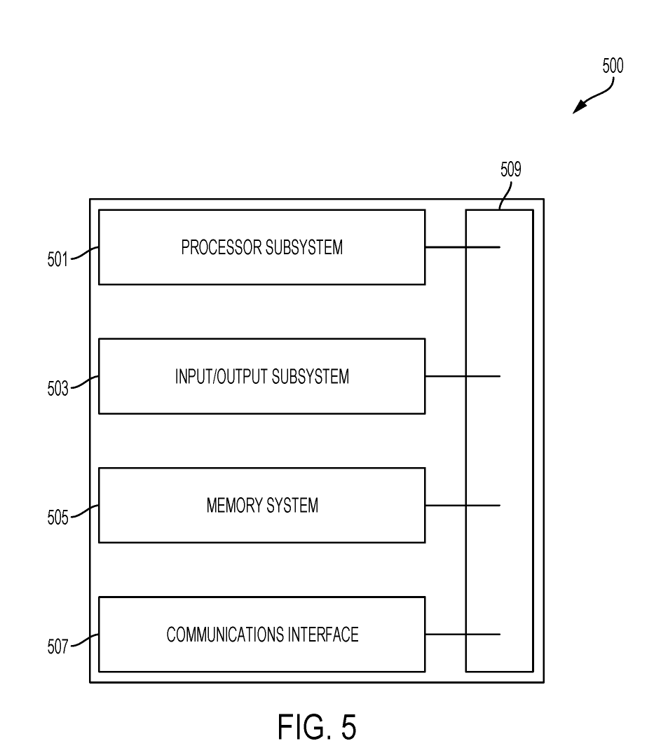

FIG. 5 is a schematic view of a mobile device as disclosed herein, which is shown as electronic device 500. Electronic device 500 is capable of implementing the system and method of remotely disabling a mobile device. Components of the electronic device 500 may comprise a processor subsystem 501, an input/output subsystem 503, a memory subsystem 505, a communications interface 507, and a system bus 509. In some non-limiting aspects, one or more than one of the electronic device 500 components may be combined or omitted such as, for example, not including the communications interface 507. In non-limiting aspects, the electronic device 500 may comprise other components not combined or comprised in those shown in FIG. 5. For example, the electronic device 500 also may comprise a power subsystem. In other non-limiting aspects, the electronic device 500 may comprise several instances of the components shown in FIG. 5. For example, the electronic device 500 may comprise multiple memory subsystems 505. For the sake of conciseness and clarity, and not limitation, only one of each of the components is shown in FIG. 5.

The processor subsystem 501 may comprise any processing circuitry operative to control the operations and performance of the electronic device 500. In various non-limiting aspects, the processor subsystem 501 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIVV) microprocessor, or other processing device. The processor subsystem 501 also may be implemented by a controller, a microcontroller, an application specific integrated circuit (ASIC), a field programmable gate array (FPGA), a programmable logic device (PLD), and so forth.

In various non-limiting aspects, the processor subsystem 501 may be arranged to run an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), and a viewer application.

In some non-limiting aspects, the electronic device 500 may comprise a system bus 509 that couples various system components together, including the processing subsystem 501, the input/output subsystem 503, and the memory subsystem 505. The system bus 509 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

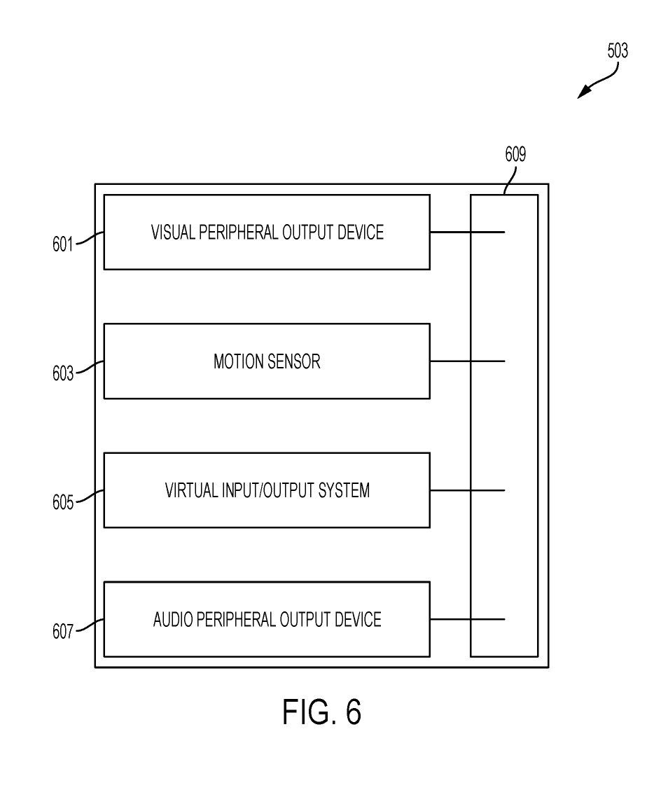

FIG. 6 shows one non-limiting aspect of the input/output subsystem 503 of the electronic device 500 shown in FIG. 5. The input/output subsystem 503 may comprise any suitable mechanism or component to at least enable a user to provide input to the electronic device 500 and the electronic device 500 to provide output to the user. For example, the input/output subsystem 503 may comprise any suitable input mechanism, including but not limited to, a button, keypad, keyboard, click wheel, touch screen, or motion sensor. In some non-limiting aspects, the input/output subsystem 503 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some non-limiting aspects, components of the input/output subsystem 503 may comprise a visual peripheral output device 601, a motion sensor 603, a virtual input/output system 605, and an audio peripheral output device 607. In some non-limiting aspects, one or more than one of the input/output subsystem 503 components may be combined or omitted such as, for example, not including the audio peripheral output device 607. Each of the components of the input/output subsystem 503 may be operatively connected to a system bus 609 configured to allow communication among or between the components. The system bus 609 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications. In other non-limiting aspects, the input/output subsystem 503 may comprise other components not combined or comprised in those shown in FIG. 6.

In some non-limiting aspects, the input/output subsystem 503 may comprise specialized output circuitry associated with output devices such as, for example, an audio peripheral output device 607. The audio peripheral output device 607 may comprise an audio output including one or more speakers integrated into the electronic device. The speakers may be, for example, mono or stereo speakers. The audio peripheral output device 607 also may comprise an audio component remotely coupled to the audio peripheral output device 607 such as, for example, a headset, headphones, and/or ear buds which may be coupled to the audio peripheral output device 607 through the communications subsystem 507.

In some non-limiting aspects, the input/output subsystem 503 may comprise a visual peripheral output device 601 for providing a display visible to the user. For example, the visual peripheral output device 601 may comprise a screen such as, for example, a Liquid Crystal Display (LCD) screen, incorporated into the electronic device 500. As another example, the visual peripheral output device 601 may comprise a movable display or projecting system for providing a display of content on a surface remote from the electronic device 500. In some non-limiting aspects, the visual peripheral output device 601 can comprise a coder/decoder, also known as a Codec, to convert digital media data into analog signals. For example, the visual peripheral output device 601 may comprise video Codecs, audio Codecs, or any other suitable type of Codec.

The visual peripheral output device 601 also may comprise display drivers, circuitry for driving display drivers, or both display drivers and circuitry for driving display drivers. The visual peripheral output device 601 may be operative to display content under the direction of the processor subsystem 501. In one non-limiting example, the visual peripheral output device 601 may be configured to display media playback information, application screens for applications implemented on the electronic device 500, information regarding outgoing communications operations, information regarding incoming communications requests, or information regarding the operation of the electronic device 500.

In some non-limiting aspects, the input/output subsystem 503 may comprise a motion sensor 603. The motion sensor 603 may comprise any suitable motion sensor operative to detect movements of electronic device 500. For example, the motion sensor 603 may be operative to detect acceleration or deceleration of the electronic device 500 as manipulated by a user. In some non-limiting aspects, the motion sensor 603 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 603 may comprise one or more two-axis acceleration motion sensors which may be operative to detect linear acceleration only along each of x or left/right and y or up/down directions (or any other pair of directions). In some non-limiting aspects, the motion sensor 603 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some non-limiting aspects, the motion sensor 603 may be operative to directly detect rotation, rotational movement, angular displacement, tilt, position, orientation, motion along a non-linear (e.g., arcuate) path, or any other non-linear motions. For example, when the motion sensor 603 is a linear motion sensor, additional processing may be used to indirectly detect some or all of the non-linear motions. For example, by comparing the linear output of the motion sensor 603 with a gravity vector (i.e., a static acceleration), the motion sensor 603 may be operative to calculate the tilt of the electronic device 500 with respect to the y-axis. In some non-limiting aspects, the motion sensor 603 may instead or in addition comprise one or more gyro-motion sensors or gyroscopes for detecting rotational movement. For example, the motion sensor 603 may comprise a rotating or vibrating element.

In some non-limiting aspects, the motion sensor 603 may comprise one or more controllers (not shown) coupled to the accelerometers or gyroscopes. The controllers may be used to calculate a moving vector of the electronic device 500. The moving vector may be determined according to one or more predetermined formulas based on the movement data (e.g., x, y, and z axis moving information) provided by the accelerometers or gyroscopes.

In some non-limiting aspects, the input/output subsystem 503 may comprise a virtual input/output system 605. The virtual input/output system 605 is capable of providing input/output options by combining one or more input/output components to create a virtual input type. For example, the virtual input/output system 605 may enable a user to input information through an on-screen keyboard which utilizes the touch screen and mimics the operation of a physical keyboard or to use the motion sensor 603 to control a pointer on the screen. As another example, the virtual input/output system 605 may enable alternative methods of input and output to enable use of the device by persons having various disabilities. For example, the virtual input/output system 605 may convert on-screen text to spoken words to enable reading-impaired persons to operate the device.

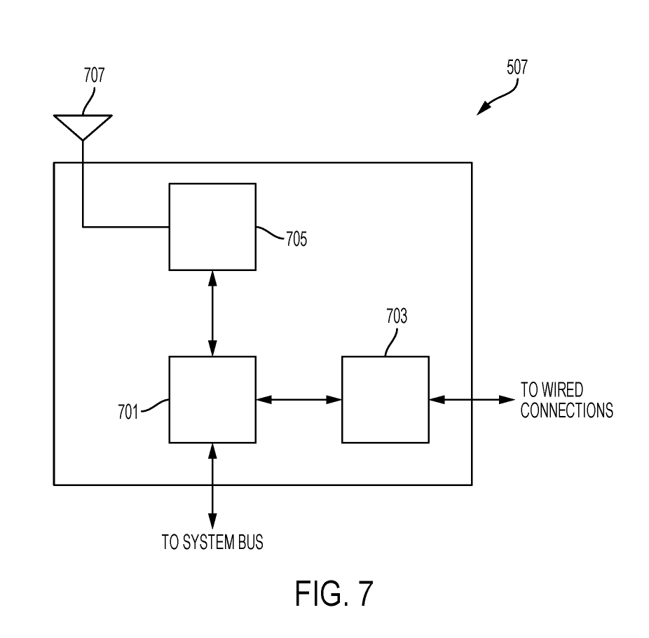

FIG. 7 shows non-limiting aspects of the communication interface 507. The communications interface 507 may comprise any suitable hardware, software, or combination of hardware and software that is capable of coupling the electronic device 500 to one or more networks and/or devices. The communications interface 507 may be arranged to operate with any suitable technique for controlling information signals using a desired set of communications protocols, services or operating procedures. The communications interface 507 may comprise the appropriate physical connectors to connect with a corresponding communications medium, whether wired or wireless.

Methods of communication comprise a network. In various non-limiting aspects, the network may comprise local area networks (LAN) as well as wide area networks (WAN) including without limitation Internet, wired channels, wireless channels, communication devices including telephones, computers, wire, radio, optical or other electromagnetic channels, and combinations or subcombinations thereof, including other devices and components capable of or associated with communicating data. For example, the communication environments comprise in-body communications, various devices, and various modes of communications such as wireless communications, wired communications, and combinations or subcombinations thereof.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment such as audio players and multimedia players, telephones such as mobile telephones and cordless telephones, and computers and computer-related devices and components such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various non-limiting aspects, the communications interface 507 may comprise one or more interfaces such as, for example, a wireless communications interface 705, a wired communications interface 703, a network interface 701, a transmit interface, a receive interface, a media interface, a system interface, a component interface, a switching interface, a chip interface, and a controller. In one non-limiting example, when implemented by a wireless device or implemented within a wireless system, the communications interface 507 may comprise a wireless interface 705 comprising one or more antennas 707, transmitters, receivers, transceivers, amplifiers, filters, and control logic, or any combination or subcombination thereof. In some non-limiting aspects, one or more interfaces of the communications interface 507 may be combined or omitted such as, for example, not including the wired communications interface 703.

In various non-limiting aspects, the communications interface 507 may provide voice and/or data communications functionality in accordance with different types of cellular radiotelephone systems. In various implementations, the described non-limiting aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described non-limiting aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

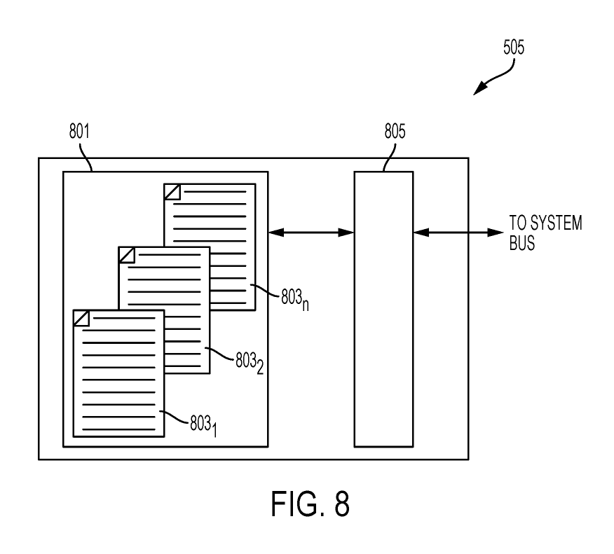

FIG. 8 shows one non-limiting aspect of the memory subsystem 505. The memory subsystem 505 may comprise any machine-readable or computer-readable media capable of storing data, including both volatile/non-volatile memory and removable/non-removable memory. The memory subsystem 505 may comprise at least one non-volatile memory unit 801. The non-volatile memory unit 801 is capable of storing one or more software programs 803ₐ-803ₙ. The software programs 803ₐ-803ₙ may comprise, for example, applications, user data, device data, and/or configuration data, or any combination or subcombination thereof. The software programs 803ₐ-803ₙ may contain instructions executable by the various components of the electronic device 500. In some non-limiting aspects, one or more than one of the memory subsystem 505 components may be combined or omitted such as, for example, not including the non-volatile memory unit 801. The interface 805 may connect to the non-volatile memory unit 801 and the system bus 509. In some additional non-limiting examples, the driving management system may further include the components and functions of the electronic device 500 as disclosed above with reference to FIGS. 5-8. In some non-limiting examples, a driving management system may comprise the electronic device 500 disclosed above, including the hardware components and their functions of the electronic device 500. The driving management system may comprise any combination or subcombination of the hardware components of the electronic device 500. Furthermore, the driving management system may include additional hardware components relative to any combination or subcombination of the hardware components of the electronic device 500. In one non-limiting example, the driving management system may comprise a configuration of hardware components that does not include any of the hardware components of the electronic device 500.

In various non-limiting aspects, the memory subsystem 505 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some non-limiting aspects, the memory subsystem 505 may contain a software program for remotely disabling the mobile computing device 500. In one non-limiting aspect, the memory subsystem 505 may contain an instruction set, in the form of a file 803ₙ for executing a method of remotely disabling the mobile computing device. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some non-limiting aspects, a compiler or interpreter is configured to convert the instruction set into machine executable code for execution by the processing subsystem 501.

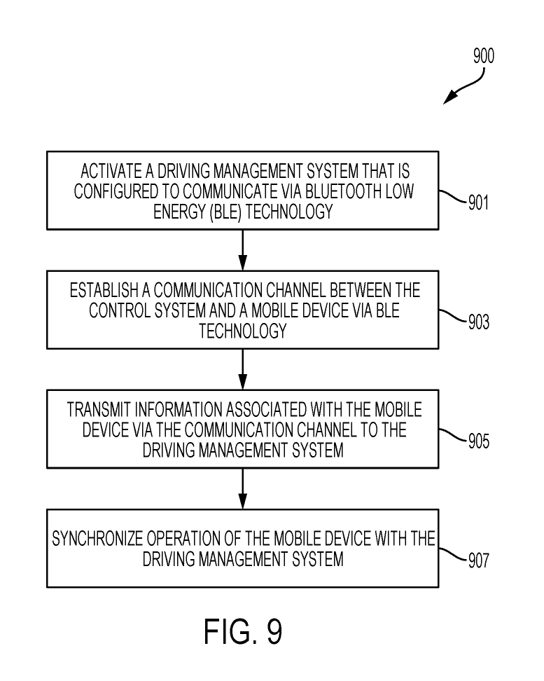

FIG. 9 shows a flow chart for a method 900 for operating a mobile device. The method 900 comprises activating 901 a driving management system that is configured to communicate via Bluetooth Low Energy (BLE) technology. The mobile device may establish 903 a communication channel between the driving management system and the mobile device via BLE technology. The mobile device may also transmit 905 information associated with the mobile device via the communication channel to the driving management system. The method 900 may further comprise synchronizing 907 operation of the mobile device with the driving management system. In one non-limiting aspect, the driving management system may comprise the mobile device detection and control system 102 described previously. The driving management system may be located within a vehicle. In one non-limiting aspect, the driving management system may further comprise a hands-free communication system of the vehicle, a navigation system of the vehicle, or any combination or subcombination thereof. In one non-limiting example, synchronizing operation of the mobile device with the driving management system may comprise synchronizing an operation of the mobile device with the driving management system. Synchronizing an operation of the mobile device with the navigation system may comprise a synchronized determination related to a route or directions from one location to a second location, such as a determination of a method to drive a vehicle from a starting location to an ending location or a determination of a length of time required to drive the vehicle from the starting location to the ending location. The determination of the length of time may be, for example, the minimum length of time required from the starting location to the ending location. The length of time may also be determined based on the minimum amount of distance necessary to drive from the starting location to the ending location.

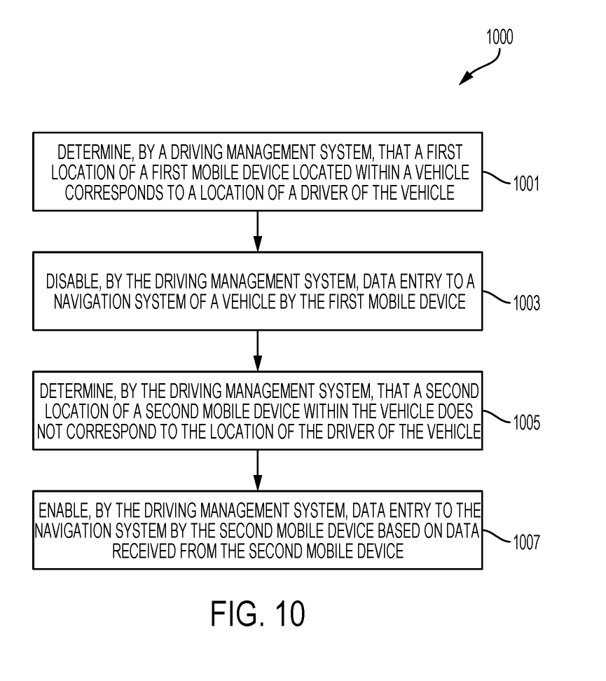

FIG. 10 shows a flow chart for a method 1000 for communicating information. The method 1000 comprises determining 1001, by the driving management system, that a first location of a first mobile device located within a vehicle corresponds to a location of a driver of the vehicle. The driving management system may disable 1003 data entry by the first mobile device to a navigation system of a vehicle such as an automobile. The driving management system may determine 1005 that a second location of a second mobile device within the vehicle does not correspond to the location of the driver of the vehicle. The driving management system may enable 1007 data entry to the navigation system by the second mobile device based on data received from the second mobile device. According to non-limiting aspects, determining 1001 that the first location of the first mobile device within the vehicle corresponds to the location of the driver of the vehicle may be continuously repeated. For example, if a vehicle is continuously moving, the determining 1001 may be repeated so that data entry to the navigation system is continuously disabled 1003 for the first mobile device. According to non-limiting aspects, determining 1005 that the second location of the second mobile device within the vehicle does not correspond to the location of the driver of the vehicle may be continuously repeated. In some non-limiting aspects, the method 1000 may further comprises transmitting, by a control module of the driving management system, a control signal to the first mobile device, wherein the control signal is configured to limit or disable an operation of the first mobile device. The control signal may be configured to prevent a communication mechanism of the first mobile device. In some non-limiting aspects, the method 1000 may further comprise sensing, by a sensing module of the driving management system, a communication signal emitted by the first mobile device or the second mobile device within a predetermined detection zone.

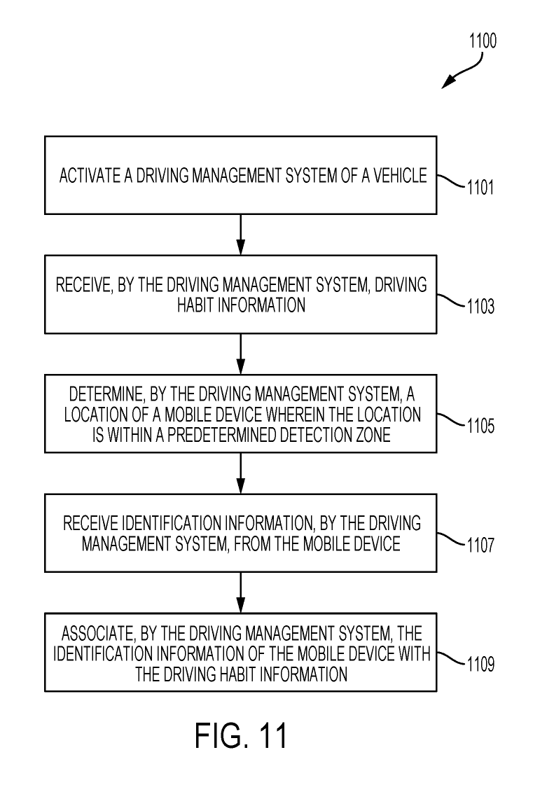

FIG. 11 shows a logic diagram for a method 1100 for collecting data. Method 1100 comprises activating 1101 a driving management system. The driving management system may receive 1103 driving habit information. The driving management system may determine 1105 a location of a mobile device, wherein the location is within a predetermined detection zone. The driving management system may receive 1107 identification information from the mobile device. The driving management system may associate 1109, the identification information with the driving habit information. In some non-limiting aspects, the predetermined detection zone comprises a three-dimensional zone in proximity to a driver seat of the vehicle. In some non-limiting aspects, the method 1100 may further comprise storing the driving habit information associated with the identification information of the mobile device in a non-transitory computer readable medium and determining, based on data sensed by a sensor of the vehicle, the driving habit information by a navigation system of the vehicle. The driving habit information may be information, such as, for example, a driving speed pattern, a brake pedal pattern, a steering wheel pattern, or any combination or subcombination thereof. In some non-limiting aspects, the method 1100 may further comprise determining, by the driving management system, the time that a point of egress or entrance of the vehicle is accessed. In one non-limiting aspect, the driving management system may comprise the mobile device detection and control system 102 discussed above.

In some non-limiting aspects, driving habit information may comprise a specific pattern or manner of driving that corresponds to a specific driver. In some non-limiting examples, a driving habit of a driver may include one or more of a driving speed pattern, a use of braking pedal pattern, and a use of a steering wheel pattern. In one non-limiting aspect, driving speed pattern may refer to, for example, a tendency of the driver to drive at a speed that is typically excessive relative to a posted speed limit on a road, the frequency that the driver maintains driving at a substantially consistent speed, and the typical acceleration of a driver who is driving a vehicle from an initial stopped state to a moving state. The typical acceleration may be calculated, for example, by averaging the acceleration to a predefined threshold such as from zero miles per hour (mph) to forty mph for each instance that the driver drives the vehicle from the initial stopped state to the moving state. Acceleration may be determined based on a different threshold, such as, for example, zero mph to twenty mph or sixty mph. In one non-limiting example, such driving speed pattern driving habit information may be determined based on a speed sensor such as a motion sensor, accelerometer, or speedometer of the vehicle. The tendency of the driver to drive at a speed that is typically excessive and the frequency that the driver maintains driving at a substantially consistent speed may be determined based on monitoring, by the driving management system, speed data of the vehicle sensed by the speed sensor.

Accordingly, in various non-limiting aspects, the vehicle may monitor data generated by one or more sensors of the vehicle and determine driving habit information based on the monitored data. In one non-limiting example, the hands-free system or the navigation system of the vehicle monitors the data and determines driving habit information based on the monitored data. In one non-limiting aspect, braking pedal pattern may refer to, for example, the typical frequency that the driver depresses a brake pedal, the typical length that the driver depresses the brake pedal, and the typical speed at which the drive depresses the brake pedal. In one non-limiting example, the driver typically depressing the brake pedal at a relatively high speed may indicate that the driver has a habit of braking the vehicle in a jerky, sudden manner. In another non-limiting aspect, steering wheel pattern may refer to, for example, the handling of the steering wheel by the driver, which may be assessed based on factors such as whether the driver steers with smooth movements rather than jerky movements. In some non-limiting aspects, the one or more sensors may sense the speed at which the driver depresses the brake pedal and the change in orientation of the steering wheel as the driver handles the steering wheel. The vehicle may monitor such sensed speed and change in orientation to determine driving habit information of the driver.

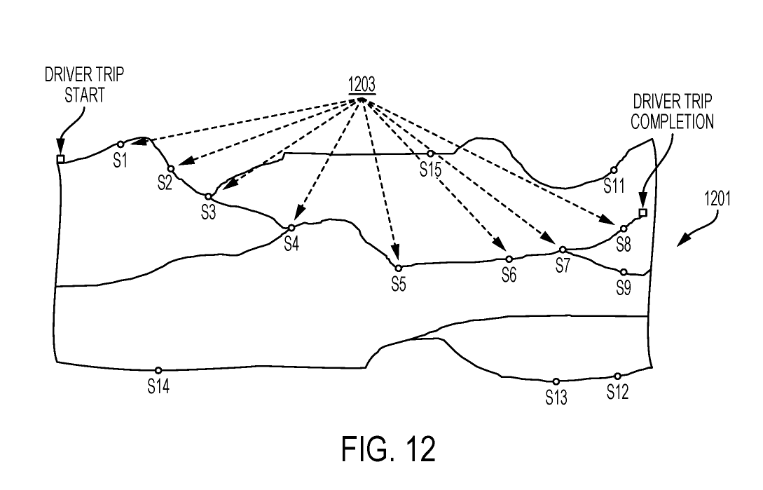

FIG. 12 illustrates a method for collecting route data using a driving management system. In one non-limiting aspect, the driving management system may comprise the mobile device detection and control system 102 described above. FIG. 12 depicts a non-limiting aspect of a route 1201 comprising labeled locations S₁-S₁₅, where location data about the locations S₁-S₁₅ may be collected by the driving management system as a vehicle moves along the route 1201. The location data may be stored in a database and may comprise GPS coordinates, latitude and longitude coordinates, or other data formats as appropriate. In one non-limiting aspect, the location data may be stored in a database located in a mobile device comprising the driving management system. In another non-limiting aspect, the database may be located in the vehicle but may be separate from a mobile device located in the vehicle. Accordingly, an onboard database may be assembled based on information from the driving management system. Furthermore, FIG. 12 shows a sample driver trip or a route 1203 that is a subset of locations S₁-S₁₅, which may be stored in a database as a set of locations. The route 1203 is shown as the ordered set of locations S₁, S₂, S₃, S₄, S₅, S₆, S₇, S₈. The route 1203 begins with the driver origin location and completes at the driver destination location shown as location S₈. Once the location data has been collected, it can be used for various purposes.

By collecting the location data for route 1203 the information about route 1203 could be used to determine where items or people have been transported. In one non-limiting aspect, the location data for route 1203 may be stored in a database that is inaccessible to a driver of the vehicle that traveled route 1203 but may be accessible to authorities, such as customs enforcement. The information would allow such authorities to track where goods or people have travelled. In another non-limiting aspect, the route information may be used by a delivery company, such that a delivery driver may not be able to access and/or modify the location data of route 1203 but a supervisor or other employee of the delivery company may be able to analyze the route 1203 to ensure the delivery driver was completing a desired route. In one non-limiting aspect, the information about route 1203 could be used to ensure that a driver utilized the most efficient route when traveling from an initial location to a final destination. The driving management system may also be used to collect information regarding the time that the location information about route 1203 is collected. The time information may be used to determine a time of service that a vehicle traveled route 1203. The time of service may be compared to a predetermined time interval to ensure that either the vehicle was operated at an appropriate time or that the cargo of the vehicle was being transported at an appropriate time.

According to non-limiting aspects, the driving management system may collect information additional to the location information associated with route 1203. In one non-limiting aspect, sensors may be located on a vehicle that enables the driving management system to collect information on when a point of egress or entrance of the vehicle is accessed. This may allow for other parties to determine if a vehicle was stopped and whether the driver exited the vehicle or whether a party entered the vehicle. Additionally, a sensor may also be located on an entrance/exit of a cargo area or a passenger area of the vehicle. Information may be gathered to determine whether the cargo area has been accessed during travel of route 1203 or if passengers have left or entered the vehicle over the travel of route 1203. Further, sensors may be placed within cargo that is being carried in the vehicle and information may be collected to determine a time when the cargo was disembarked from the vehicle. This information may be used to ensure proper delivery of items. To perform the steps of the method illustrated by FIG. 12, and as disclosed above, the driving management system may further comprise computer executable instructions stored in a non-transitory computer readable medium. The computer executable instructions may be executed by a computer or a computer system such as, for example, a processor or a microprocessor. In a non-limiting example, components of the driving management system similar to the components disclosed previously with reference to FIGS. 5-8 may execute the computer executable instructions to perform the steps of the method illustrated by FIG. 12.

Examples of mobile devices suitable for implementing the systems and methods disclosed herein comprise, but are not limited to: the Apple iPhone™ and iPod™; RIM Blackberry® Curve™, Pearl™, Storm™, and Bold™; Hewlett Packard Veer; Palm® (now HP) Pixi™; Pre™; Google Nexus S™, Motorola DEFY™, Droid (generations 1-3), Droid X, Droid X2, Flipside™, Atrix™, and Citrus™; HTC Incredible™, Inspire™, Surround™, EVO™, G2™, HD7, Sensation™, Thunderbolt™, and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™; Sony Ericsson Xperia™ Play.

Examples of tablet computing devices suitable for implementing the systems and methods disclosed herein comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

In some non-limiting aspects, the systems and methods disclosed herein may be combined with one or more additional mobile device control methods. Additional methods and systems that may be combined with the systems and methods disclosed herein are disclosed in U.S. Pat. App. Pub. Nos. 2011/0183601 and 2012/0055726, the disclosures of which are incorporated by reference herein in their entireties.

In various non-limiting aspects, a mobile device may be implemented as a handheld portable device, computing device, computer, mobile telephone, sometimes referred to as a smartphone, tablet personal computer (PC), kiosk, desktop computer, or laptop computer, or any combination thereof. Examples of smartphones include, for example, an iPhone®, an iPod®, an iPad®, a device operating the Android operating system (“OS”) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to communicate with clients and the host system via a communications network. Computing devices may include a suitable browser software application (e.g., Internet Explorer, Internet Explorer Mobile, Chrome, Safari, Firefox, Blazer, etc.) for enabling the user to display and interact with information exchanged via a communication network.

Although some non-limiting aspects of the mobile device may be described with a mobile or fixed computing device implemented as a smart phone, personal digital assistant, laptop, desktop computer by way of example, it may be appreciated that the non-limiting aspects are not limited in this context. For example, a mobile computing device may comprise, or be implemented as, any type of wireless device, mobile station, or portable computing device with a self-contained power source (e.g., battery) such as the laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. Additional mobile devices include, for example, wearable mobile devices such as, for example, wearable health monitors produced by BodyMedia, JawBone, FitBit, along with devices like the Apple® Watch and Google® Glass.

In various non-limiting aspects, the mobile device may provide voice and/or data communications functionality in accordance with different types of cellular radiotelephone systems. Examples of cellular radiotelephone systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), CDMA-2000, Universal Mobile Telephone System (UMTS) systems, WiMAX (Worldwide Interoperability for Microwave Access), LTE (Long Term Evolution) and so forth.

In various non-limiting aspects, the mobile device may be configured to provide voice and/or data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.1a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. The mobile computing device 700 may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques. An example of EMI techniques may include passive or active radio-frequency identification (RFID) protocols and devices.

In various non-limiting aspects, the interface device is configured to couple to a communication interface to access the cloud (Internet). The communication interface may form part of a wired communications system, a wireless communications system, or a combination of both. For example, the mobile device 302 may be configured to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile device may be arranged to communicate information over one or more types of wireless communication links such as a radio channel, satellite channel, television channel, broadcast channel infrared channel, radio-frequency (RF) channel, WiFi channel, a portion of the RF spectrum, and/or one or more licensed or license-free frequency bands. In wireless implementations, the mobile device may comprise one or more interfaces and/or components for wireless communication such as one or more transmitters, receivers, transceivers, amplifiers, filters, control logic, wireless network interface cards (WNICs), antennas, and so forth.

Broad categories of previously discussed mobile devices include, for example, personal communication devices, handheld devices, and mobile telephones. In various aspects, a mobile device may refer to a handheld portable device, computer, mobile telephone, smartphone, tablet personal computer (PC), laptop computer, and the like, or any combination thereof. Examples of smartphones include any high-end mobile phone built on a mobile computing platform, with more advanced computing ability and connectivity than a contemporary feature phone. Some smartphones mainly combine the functions of a PC.

While various details have been set forth in the foregoing description, it will be appreciated that the various aspects of the techniques disclosed herein may be practiced without these specific details. One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Further, while several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, while materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, combinations, and equivalents.

For conciseness and clarity of disclosure, selected aspects of the foregoing disclosure have been shown in block diagram form rather than in detail. Some portions of the detailed descriptions provided herein may be presented in terms of instructions that operate on data that is stored in one or more computer memories or one or more data storage devices (e.g. floppy disk, hard disk drive, Compact Disc (CD), Digital Video Disk (DVD), or digital tape). Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the foregoing disclosure, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. In one form, several portions of the subject matter described herein may be implemented via an application specific integrated circuits (ASIC), a field programmable gate array (FPGA), a digital signal processor (DSP), or other integrated formats. However, those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In some instances, one or more elements may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other. It is to be understood that depicted architectures of different components contained within, or connected with, different other components are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated also can be viewed as being “operably connected,” or “operably coupled,” to each other to achieve the desired functionality, and any two components capable of being so associated also can be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components, and/or electrically interacting components, and/or electrically interactable components, and/or optically interacting components, and/or optically interactable components.

In other instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present disclosure have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “one form,” or “a form” means that a particular feature, structure, or characteristic described in connection with the aspect is included in at least one aspect. Thus, appearances of the phrases “in one aspect,” “in an aspect,” “in one form,” or “in an form” in various places throughout the specification are not necessarily all referring to the same aspect. Furthermore, the particular features, structures or characteristics may be combined in any suitable manner in one or more aspects.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

The functions of the various functional elements, logical blocks, modules, and circuits elements described in connection with the non-limiting aspects disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some non-limiting aspects also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the non-limiting aspects described herein illustrate example implementations, and that the functional elements, logical blocks, modules, and circuits elements may be implemented in various other ways which are consistent with the described non-limiting aspects. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual non-limiting aspects described and illustrated herein has discrete components and features which may be readily separated from or combined with the features of any of the other several non-limiting aspects without departing from the scope of the present disclosure. Any recited method can be carried out in the order of events recited or in any other order which is logically possible.

It is noted that reference to “one non-limiting aspect” or “a non-limiting aspect” means that a particular feature, structure, or characteristic described in connection with the non-limiting aspect is comprised in at least one non-limiting aspect of the present disclosure. The appearances of the phrase “in one non-limiting aspect” or “in a non-limiting aspect” in the specification are not necessarily all referring to the same non-limiting aspect.

Unless specifically stated otherwise as apparent from the foregoing disclosure, it is appreciated that, throughout the foregoing disclosure, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that some non-limiting aspects may be described using the expression “coupled” and “connected” along with their derivatives. These terms are not intended as synonyms for each other. For example, some non-limiting aspects may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, non-limiting aspects, and non-limiting aspects as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary non-limiting aspects and non-limiting aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed non-limiting aspects and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or non-limiting aspects disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the non-limiting aspects have been illustrated as described above, many modifications, substitutions, changes and equivalents will now occur to those skilled in the art. It is therefore to be understood that the appended claims are intended to cover all such modifications and changes as fall within the scope of the disclosed non-limiting aspects.

Various aspects of the subject matter described herein are set out in the following numbered examples:

1. A method for operating a mobile device comprising: activating a driving management system that is configured to communicate via Bluetooth Low Energy (BLE) technology; establishing a communication channel between the driving management system and a mobile device via BLE technology; transmitting information associated with the mobile device via the communication channel to the driving management system; and synchronizing operation of the mobile device with the driving management system.

2. The method of example 1, wherein activating a driving management system comprises activating a driving management system that is located within a vehicle.

3. The method of example 2, wherein activating a driving management system comprises activating a driving management system comprising a hands-free communication system.

4. The method of example 3, wherein synchronizing operation of the mobile device with the driving management system comprises synchronizing an operation of the mobile device with the hands-free communication system of the driving management system.

5. The method of any of examples 2 through 4, wherein synchronizing operation of the mobile device with the driving management system comprises synchronizing an operation of the mobile device with a navigation system of the driving management system.

6. The method of any of examples 2 through 5, further comprising: reading, by the driving management system, a first text message, wherein the first text message is an inbound text message; and replying, by the driving management system, via a voice activated second text message, wherein the voice activated second text message is an outbound text message.

7. A method for communicating information comprising: determining, by a driving management system, that a first location of a first mobile device located within the vehicle corresponds to a location of a driver of the vehicle; and disabling, by the driving management system, data entry to a navigation system of a vehicle by the first mobile device.

8. The method of example 7, wherein the determining that the first location of the first mobile device within the vehicle corresponds to the location of the driver of the vehicle is continuously repeated.

9. The method of any of examples 7 through 8, further comprising: determining, by the driving management system, that a second location of a second mobile device within the vehicle does not correspond to the location of the driver of the vehicle; and enabling, by the driving management system, data entry to the navigation system by the second mobile device based on data received from the second mobile device.

10. The method of example 9, wherein the determining that the second location of the second mobile device within the vehicle does not correspond to the location of the driver of the vehicle is continuously repeated.

11. The method of any of examples 7 through 10, further comprising: transmitting, by a control module of the driving management system, a control signal to the first mobile device, wherein the control signal is configured to limit or disable an operation of the first mobile device.

12. The method of example 11, wherein transmitting the control signal to the first mobile device comprises transmitting a control signal configured to prevent a communication mechanism of the first mobile device.

13. The method of any of examples 7 through 12, further comprising: sensing, by a sensing module of the driving management system, a communication signal emitted by the first mobile device or the second mobile device within a predetermined detection zone.

14. A method for collecting data comprising: activating a driving management system of a vehicle; receiving, by the driving management system, driving habit information; determining, by the driving management system, a location of a mobile device wherein the location is within a predetermined detection zone; receiving identification information, by the driving management system, from the mobile device; and associating, by the driving management system, the identification information of the mobile device with the driving habit information.

15. The method of example 14, wherein determining a location of a mobile device wherein the location is within a predetermined detection zone, wherein the predetermined detection zone comprises a three-dimensional zone in proximity to a driver seat of the vehicle.

16. The method of any of examples 14 through 15, further comprising: storing the driving habit information associated with the identification information of the mobile device in a non-transitory computer readable medium; determining, based on data sensed by a sensor of the vehicle, the driving habit information by a navigation system of the vehicle.

17. The method of example 16, wherein storing the driving habit information comprises storing a driving speed pattern.

18. The method of any of examples 14 through 17, wherein storing the driving habit information comprises storing a breaking pedal pattern.

19. The method of any of examples 14 through 18, wherein storing the driving habit information comprises storing a steering wheel pattern.

20. The method of any of examples 14 through 19, further comprising: determining, by the driving management system, a time that a point of egress or entrance of the vehicle is accessed.

1-6. (canceled)

7. A method for communicating information comprising:
determining, by a driving management system, that a first location of a first mobile device located within the vehicle corresponds to a location of a driver of the vehicle; and
disabling, by the driving management system, data entry to a navigation system of a vehicle by the first mobile device.

8. The method of claim 7, wherein the determining that the first location of the first mobile device within the vehicle corresponds to the location of the driver of the vehicle is continuously repeated.

9. The method of claim 7, further comprising:
determining, by the driving management system, that a second location of a second mobile device within the vehicle does not correspond to the location of the driver of the vehicle; and
enabling, by the driving management system, data entry to the navigation system by the second mobile device based on data received from the second mobile device.

10. The method of claim 9, wherein the determining that the second location of the second mobile device within the vehicle does not correspond to the location of the driver of the vehicle is continuously repeated.

11. The method of claim 7, further comprising:
transmitting, by a control module of the driving management system, a control signal to the first mobile device, wherein the control signal is configured to limit or disable an operation of the first mobile device.

12. The method of claim 11, wherein transmitting the control signal to the first mobile device comprises transmitting a control signal configured to prevent a communication mechanism of the first mobile device.

13. The method of claim 7, further comprising:
sensing, by a sensing module of the driving management system, a communication signal emitted by the first mobile device or the second mobile device within a predetermined detection zone.

14-20. (canceled)
